(19) United States
(12) Patent Application Publication
(10) Pub. No.: US 2005/0101025 A1
(43) Pub. Date: May 12, 2005

(54) Apparatus for proteins and nucleic acids analysis

(76) Inventor: Winston Zonh Ho, Hacienda Heights, CA (US)

Correspondence Address: Winston Zonh Ho, 14541 Langhill Drive, Hacienda Heights, CA, 91745, US

(21) Appl. No.: 10/706,535

(22) Filed: Nov. 12, 2003

(51) Int. Cl. B01L 3/02

(52) U.S. Cl. 436/86; 422/100

(57) ABSTRACT

The present invention is related to a UV transmissible pipette tip and UV absorbance measurement apparatus to provide a fast, convenient, economical and less contaminated means of measuring yields, purities, and concentrations of proteins, DNA, or RNA samples inside said pipette tip by UV absorbance analysis. The pipette tip is formed of a plastic material transparent between 200 nm and 350 nm. The pipette tip not only can be used for sampling and dispensing accurate liquid volumes, but also can be defined as a photocell for absorbance measurement.

### FIELD OF THE INVENTION

The present invention is related to a UV transmissible pipette tip and an UV absorbance measurement apparatus for measuring the absorbance of a sample inside the pipette tip. More particularly, the present invention relates to an absorbance measuring apparatus that provides a fast, direct, and convenient means of measuring yields, purities, and concentrations of proteins, DNA, or RNA samples inside a pipette tip by UV absorbance analysis.

### BACKROUND OF THE INVENTION

The recent growth of biotechnology research and development has increased the demand to measure the concentration of biological samples in a very small volume. Molecular biologists routinely perform nucleic acids (DNA, RNA, and oligonucleotide primers), proteins, and bacterial cell extracts measurements for genomic and proteomic analysis and drug discovery research. Since most of proteins and nucleic acids absorb radiation in the ultraviolet (UV) region of the electromagnetic spectrum, UV absorption spectroscopy has been used to measure the concentration of these samples. Given that biological samples are expensive and contaminated easily, there is room for improvement in conventional UV spectroscopy. Conventional UV spectroscopy is performed by pipetting several milliliters (ml) of biological samples into a square cuvet, positioning the cuvet into a holder in a spectrometer, and scanning the spectrum over the whole spectral range of interest. This method is precise and accurate, but it consumes a large volume of sample and the sample can be contaminated easily due to the transportation between the sampling tubes and cuvets. Moreover, the process is labor intensive and time consuming, especially when hundreds of samples need to be measured.

Pipette is a continuously adjustable, general-purpose micropipette for sampling and dispensing accurate liquid volumes. It operates on an air displacement principle and uses detachable disposable pipette tips. The adjusted delivery volume is displayed digitally on a handle. Pipettes can precisely deliver 0.5 μl to 5,000 μl of liquids with 0.01 μl fine adjustment. Each pipette is fitted with a pipette tip ejector system to eliminate the risk of contamination. Pipettes are available from various vendors (Fisher, Thermo Labsystems, Eppendorf, etc.). Disposable pipette tip is one of the most consumable items in biological and pharmaceutical laboratories. Pipette tips are made of plastic materials. They are designed for one time use. Because pipette tips are designed for liquid delivery, all current pipette tips are not optically transparent, especially in the UV region. Therefore, they are not suitable for UV absorbance measurement.

U.S. Pat. No. 5,844,686 to Treptow and Harnack, entire contents of which are incorporated herein by reference, discloses a handheld apparatus integrated with both pipette and photometrical meter into a unit. The method is designed to measures the reduction of light transmission by means of a sample volume. Because the pipette tip was not UV transmissible, the pipette tip cannot be used as a photocell to measure proteins and nucleic acids in the UV region.

U.S. Pat. No. 6,396,541 to Taguchi and Hiramatsu, entire contents of which are incorporated herein by reference, discloses an absorbance-measuring pipette includes a pipette adapter. The pipette adapter, connecting between a pipette and pipette tip, is used to introduce a light source into the inner space of the tip. This adapter has an optical reflector, windows, and is attachable to a pipette and a pipette tip. A light beam is transmitting vertically toward a sample suction portion of the tip. Thus, the optical path is parallel to the axis of the pipette.

### SUMMARY OF THE INVENTION

In accordance with preferred embodiments of the present invention, an UV transmissible pipette tip not only can be used for sampling and dispensing accurate liquid volumes, but also can be defined as a photocell for absorbance measurement. The pipette tip is made of a plastic material having an average optical density that is no more than approximately 0.2 between wavelengths of 200 nm and 350 nm. One of the preferred embodiments of the pipette tip is to have at least two plane-parallel windows on opposite sides of its wall for light beam transmitting. Some aspects of the invention relate to a UV transmissible pipette tip for use in dispensing and assaying samples, the pipette tip being formed from plastic material that is UV transmissible between wavelengths of 200 nm and 350 nm.

Another object of this invention is to provide a UV absorbance measuring apparatus for measuring concentrations of proteins and/or nuclei acids samples, the apparatus comprising a pipette tip, a pipette for drawing the samples into the pipette tip, a light beam transmitting the pipette tip and the sample; and an optical detector for measuring the intensity of the transmitted light beam. The UV light beam has wavelengths between 200 nm and 350 nm.

Another object of this invention is to provide a UV absorbance measuring apparatus for measuring the absorbance of a sample consisted of proteins and/or nucleic acids. Based on the measurement of a set of wavelengths comprising 230 nm, 260 nm, 280 nm, and 320 nm; the yield, purity, and concentration of protein and nucleic acid samples can be measured directly and conveniently inside the pipette tip.

Some aspects of the invention relate to a method for measuring concentrations of protein or nucleic samples, comprising steps of: providing a UV absorbance measuring apparatus, wherein the apparatus comprises a UV transmissible pipette tip for use in dispensing and assaying samples, the pipette tip being formed from plastic materials that are UV transmissible; transporting the samples into the pipette tip; passing a light beam through the pipette tip and the samples; measuring intensity of the transmitted light beam; and calculating the concentrations of the samples using the measured intensity.

The present UV transmissible pipette tip and measuring apparatus has many advantages. There is no tedious liquid transfer between test tubes and cuvets for spectral photometer measurement. The samples in pipette tips can be directly dispensed into reaction containers for downstream applications. There is no loss of precious samples and no cross contamination caused by multiple liquid transporting. By simply positioning the pipette tip in an optical beam path, UV absorbance of the samples can be accurately measured. It should be understood, however, that the detail description and specific examples, while indicating preferred embodiments of the present invention, are given by way of illustration and not of limitation. Further, as will become apparent to those skilled in the art, the teaching of the present invention can be applied to other devices for measuring a variety of organics, chemicals and other materials.

### BRIEF DESCRIPTION OF THE DRAWINGS

Additional objects and features of the present invention will become more apparent and the invention itself will be best understood from the following Detailed Description of Exemplary Embodiments, when read with reference to the accompanying drawings.

FIG. 1 shows protein absorbance in the UV region.

FIG. 2 shows nucleic acid absorbance in the UV region.

FIG. 3 is a perspective view of a UV transmissible pipette tip having two plane-parallel windows as part of its sidewall.

FIG. 4 is a top view of a horizontal cut-away pipette tip with two plane-parallel windows as part of its sidewall.

FIG. 5 is a schematic diagram of the UV absorbance measuring apparatus comprises a pipette tip, a pipette, a light beam, and a detector for measuring the concentrations of proteins and/or nuclei acids samples.

FIG. 6 shows examples of optical interference filters with narrow transmission peaks at 260 nm and 280 nm.

FIG. 7 is an overall view of a pipette/pipette tip and a standalone UV absorbance measuring system.

### DETAILED DESCRIPTION OF EXEMPLARY EMBODIMENTS

The preferred embodiments of the present invention described below relate particularly to a UV transmissible pipette tip and a UV absorbance measuring apparatus for measuring the concentration of biological samples inside the pipette tip. While the description sets forth various embodiment specific details, it will be appreciated that the description is illustrative only and should not be construed in any way as limiting the invention. Furthermore, various applications of the invention, and modifications thereto, which may occur to those who are skilled in the art, are also encompassed by the general concepts described below.

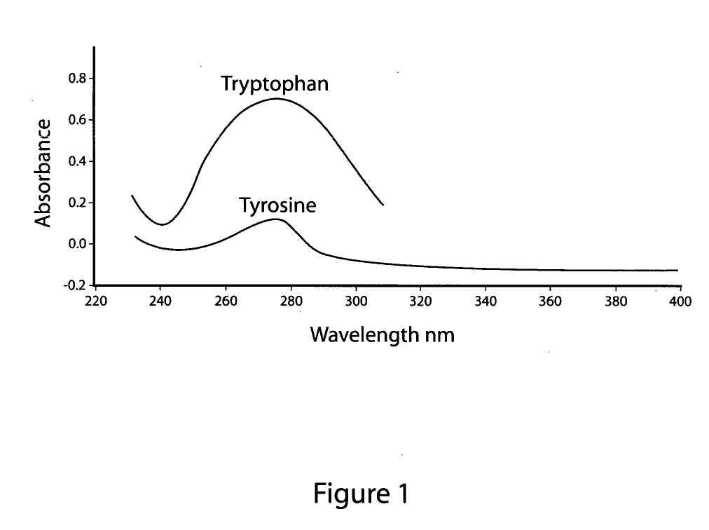

Although none of the 20 amino acids found in proteins absorbs light in the visible range, three amino acids with aromatic moieties—tyrosine, tryptophan, and phenylalanine—absorb light significantly in the ultraviolet. Since most proteins contain tyrosine residues, measurement of light absorption at 280 nm in a spectrophotometer is a convenient means of estimating the protein content of a solution. If one knows the number of tyrosines and tryptophans in a protein, one can calculate an extinction coefficient for that protein for a given wavelength and use this to measure the protein concentration in solution. As shown in the FIG. 1, the extinction coefficients at 280 nm UV region for tyrosine and tryptophan are 1280 cm⁻¹M⁻¹ and 5690 cm⁻¹M⁻¹, respectively. A trough is usually observed at 230 nm. Some proteins, such as histones or protamines, contain few or no aromatic residues and have little or no absorbance at 280 nm. These variations in amino acid composition can have an impact on a protein's absorbance at 280 nm. Peptide bonds absorb at 230 nm and are a more constant indicator of the presence of protein in a sample. Thus, absorbance readings measured both at 230 nm and at 280 nm provide a more accurate estimate of proteins or peptides that may be present in nucleic acid samples. A rule of thumb that can be used to monitor total protein concentration in a sample of a mixture of proteins is: optical density, OD₂₈₀=1.0 absorbance unit for a 1 mg/ml protein solution when using a 1 cm cell.

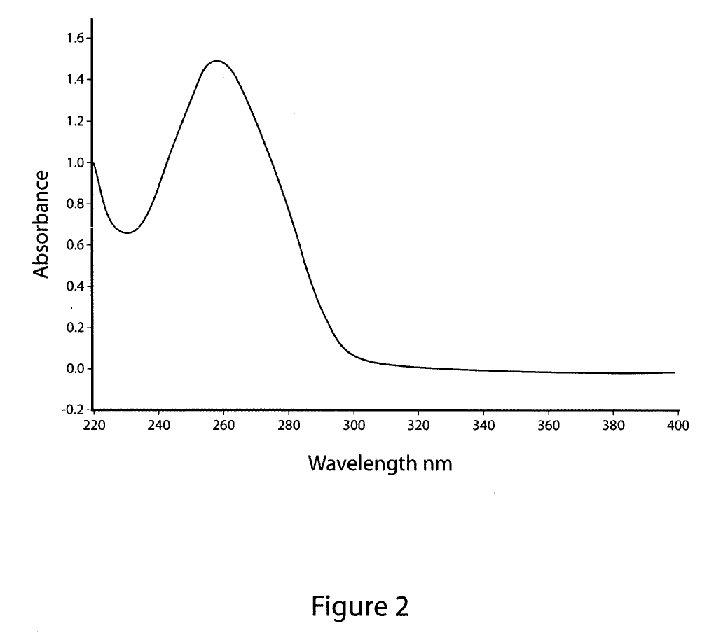

The ratio of absorbance readings at A₂₈₀/A₂₆₀ was first described by Warburg and Christiani to assess protein purity in the presence of nucleic acid contaminants. Today this method is used to determine both nucleic acid purity and yield by measuring the absorbance ratio, A₂₆₀/A₂₈₀. Nucleic acids absorb UV light with maximum for the four nucleotides components center primarily at 260 nm, as shown in FIG. 2. The concentration and purity of the nucleic acids (NA) is determined by optical density measurements at 230 nm, 260 nm and 280 nm. When DNA or RNA has been isolated from small amounts of cells or tissue, the expected yields are such that, absorbance must be measured directly, without dilution of the sample. The amount of NA isolated varies due to a number of factors, including the source and the integrity of the samples. Absorbance readings should be greater than 0.05 to ensure significance.

A₂₆₀=1 corresponds to approximately 40 μg of NA per ml

The ratio between the reading at 260 nm and 280 nm, gives an estimate of NA purity: An A₂₆₀/A₂₈₀ absorbance ratio in the range of 1.8 to 2.0 would indicate a pure preparation of nucleic acid.

An ₂₆₀/A₂₃₀ or A₂₆₀/A₂₈₀ ratio less than 1.8, would indicate that the lysis solution from the extraction buffer, such as protein, is still present. If this is the case, the NA should be washed again.

NA concentration (μg/ml)=(A₂₆₀-A₂₈₀)×40 (RNA extinction coefficient)×dilution factor

Absolute NA yield (μg)=NA concentration x volume of NA solution.

Current pipette tips are made of natural colored polypropylenes. They are not optically clear and absorb UV light with an optical density larger than 2.0. Costly materials, such as quartz, borosilicate glass, and fused silica, are used to make UV photocells for spectral photometric applications. Recently, UV polymers become available, examples of low UV absorption materials are polyolefins, fluoropolymers, polyester, non-aromatic hydrocarbons, polyvinylidene chloride, and polychlorotrifluoroethylenes. The polymeric materials may be a homopolymer or a copolymer, and are suitable for injection molding. Specific examples of UV transmissible materials include Kynar™ film and KelF™ film of 3M (Minneapolis, Minn.) and Aclar™ film of Allied Signal (Morristown, N.J.). A good plastic material for UV transmissible pipette tip should be low cost and have an average optical density that is no more than approximately 0.2 between wavelengths of 200 nm and 350 nm. While particular UV transmissible materials have been disclosed herein, it should be understood that this list is merely exemplary and not limiting.

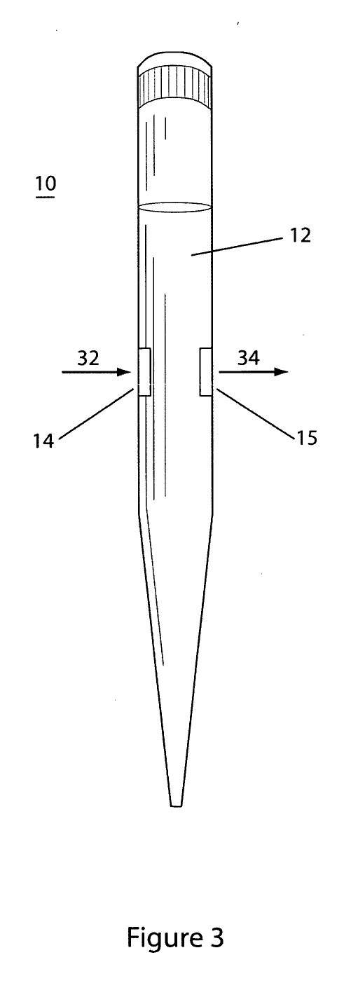

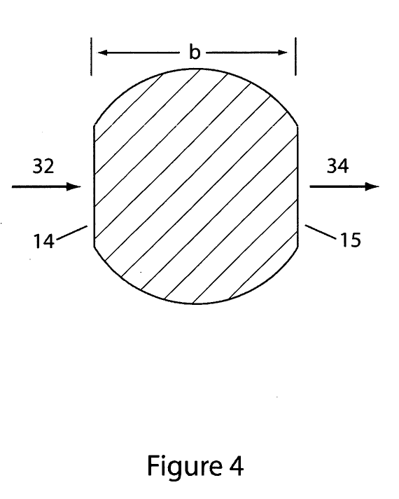

The spectrophotometer samples were read using a standard 1.0 cm quartz cuvet in the instrument, while the samples for the pipette tips are read across the pipette tip. In order to obtain absorption measurements with precision and reproducibility, it is critical to have a fixed optical path length. A curved sidewall, acts like a lens, distorts the light beam and changes the optical path length. The preferable embodiment of the pipette tip 10 is to have two plane-parallel windows 14, 15, as shown in FIG. 3 and FIG. 4. FIG. 4 shows a top view of a horizontal cut-through of the tip. A light beam 32 is directed perpendicularly to the flat windows, it transmits 34 through the sample 12 inside the pipette tip without distortion. The pipette tip with two plane-parallel windows, defined as a photocell, has a fixed optical path length, b. The absorbance measurement is based on the samples in the photocell.

According to the Beer-Lambert law: A=ε×b×C. Here, A is the absorbance in the unit of optical density (OD), ε is the extinction coefficient of the proteins or nucleic acids at a particular wavelength in M⁻¹ cm⁻¹, b is the optical path length through the sample in cm, and C is the sample concentration. The optical path length across a pipette tip is approximately 0.05 cm to 1.0 cm depends on the size of pipette tip. It is understood that the windows are located at a sample suction portion of the pipette tip; therefore the window portion is filled with liquid samples. The absorbance of a blank sample is subtracted from the sample absorbance readings. The optical path length inside the pipette tip is used to calculate the concentration of the sample at a particular wavelength.

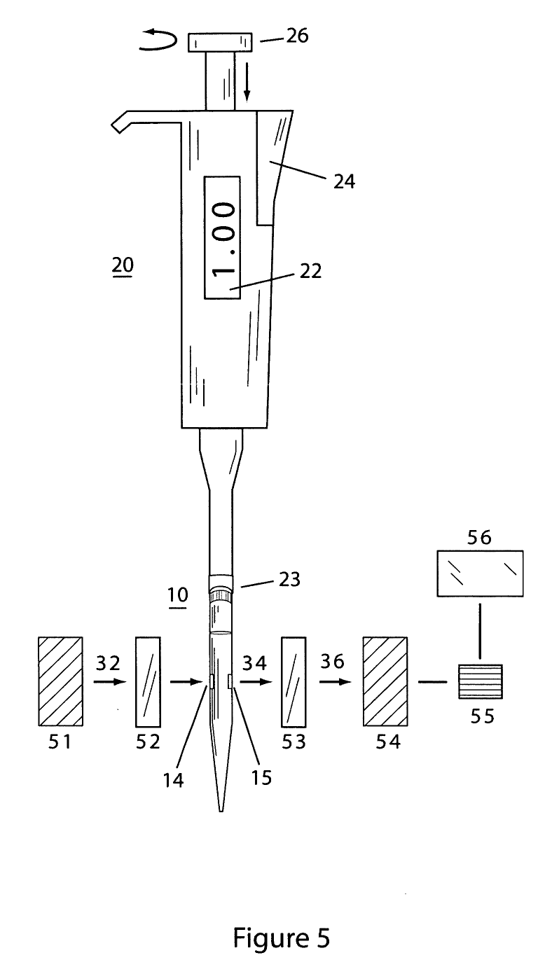

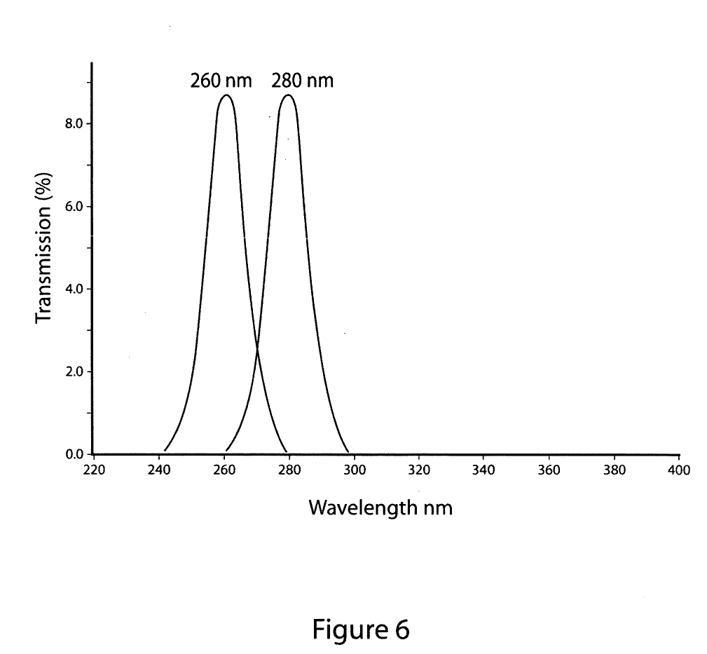

In addition to a pipette 20 and a pipette tip 10, FIG. 5 shows an overall view of the absorbance measuring apparatus comprising a light source 51, an optical filter 52 or wavelength diffraction elements 53, and an optical signal detection system 54. The delivery volume is set using an adjustable operating button 26 on the top of the pipette. The delivery volume is displayed digitally 22 on the pipette. The pipette tip 10 is easily fitted to a pipette 20 through a connector 23. By pushing down the operating button 26, the exact amount of liquid sample is drawn into the pipette tip. Furthermore, the pipette is fitted with a tip ejector system 24 to eliminate the risk of contamination. For UV absorbance measurement, the windows 14, 15 on the pipette tip are positioned in the optical path of a light beam. The light beam 32 generated from a light source 51 travels through the pipette windows, samples, filters or gratings, to reach a detector 54. Common UV lamp sources are Deuterium lamp and Xenon lamp, which cover the entire 200 nm-350 nm ranges. Tungsten lamp, light emission diodes (LED), and diode lasers are visible light sources. The lamp is on for a few seconds at a time to preserve a long lifetime. Fix wavelength optical filters, sharp cut-off filters, or optical gratings are commonly used for wavelength selection. Multiple optical filters are installed in a circular holder for multiple wavelengths selection. Interference optical filters, as shown in FIG. 6, provide transmission of relatively narrow bandwidths for any particular wavelengths of interest. The typical bandwidth of an interference filter is 5 nm to 10 nm. The transmitted light is measured with a photodiode or photomultiplier. The detector 54 is then interfaced to an analog-to-digital converter and an advanced signal processor 55.

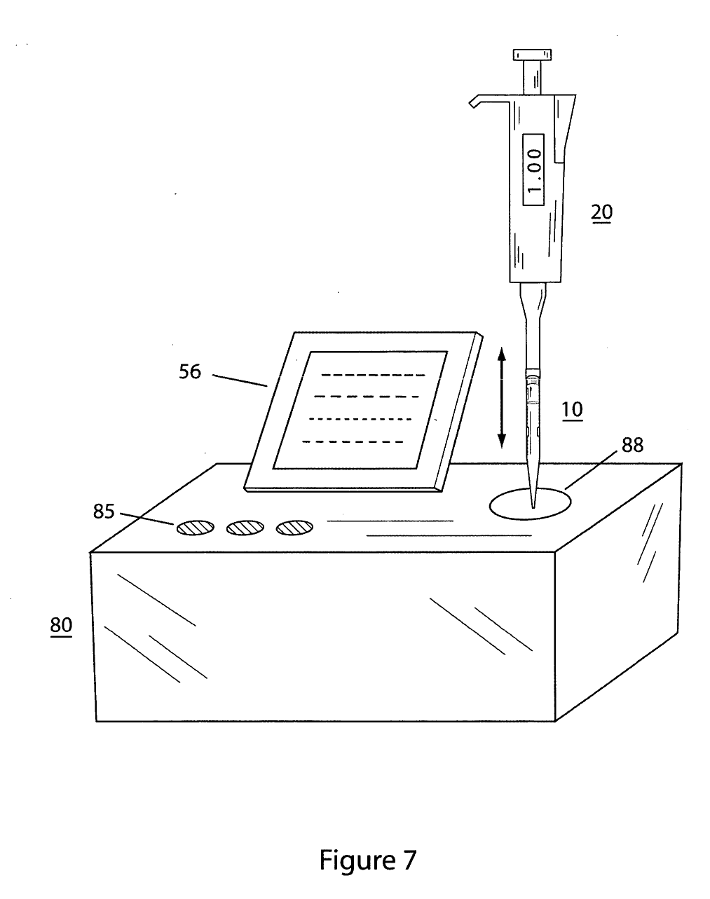

The above-mentioned optoelectronic components in the UV absorbance measuring apparatus can be constructed as a standalone system 80 as shown in FIG. 7 or can be integrated into a pipette as a unit. For standalone system, the operation procedure is relatively easy. The operator simply inserts the pipette/pipette tip into a sensing port 88 and pushes the buttons 85, the system 80 will display the results on the display 56. The absorbance results, yields, purities, and concentrations of proteins, DNA, or RNA samples inside the pipette tip are shown on the LCD display 56. In general, the data acquisition and analysis of the optical parameters are well known to an ordinary person who is skilled in the art.

Some aspects of the invention relate to a method for measuring concentrations of protein or nucleic samples, comprising: (a) providing a UV absorbance measuring apparatus, wherein the apparatus comprises a UV transmissible pipette tip for use in dispensing and assaying samples, the pipette tip being formed from plastic materials that are UV transmissible; transporting the samples into the pipette tip; (b) passing a light beam through the pipette tip and the samples; (c) measuring intensity of the transmitted light beam; and (d) calculating the concentrations of the samples using the measured intensity. In one embodiment, the light beam comprises a UV light having wavelengths between 200 nm and 350 nm. In another embodiment, the concentrations of the samples are calculated by subtracting the intensity of the transmitted light beam through a blank pipette tip from the intensity of the transmitted light beam through the pipette tip that contains samples.

From the foregoing, it should now be appreciated that a UV absorbance measuring apparatus comprising a pipette, UV transmissible pipette tip, light source, optical filters, and optical signal detection system for measuring the concentration of proteins and nucleic acids in a pipette tip based photocell has been disclosed. It is also generally applicable for monitoring organics, polymers, chemicals, or other materials inside a pipette tip. While the invention has been described with reference to a specific embodiment, the description is illustrative of the invention and is not to be construed as limiting the invention. Various modifications and applications may occur to those skilled in the art without departing from the true spirit and scope of the invention as described by the appended claims.

1. A UV transmissible pipette tip for use in dispensing and assaying samples, said pipette tip being formed from plastic material that is UV transmissible between wavelengths of 200 nm and 350 nm.

2. The UV transmissible pipette tip of claim 1, wherein said plastic material has an average optical density that is no more than about 0.2 between wavelengths of 200 nm and 350 nm.

3. The UV transmissible pipette tip of claim 1, wherein said plastic material is selected from a group consisting of polyolefins, fluoropolymers, polyester, non-aromatic hydrocarbons, polyvinylidene chloride, and polychlorotrifluoroethylenes.

4. The UV transmissible pipette tip of claim 1, wherein said plastic material is selected from a group consisting of Kynar film, KelF film, and Aclar film.

5. The UV transmissible pipette tip of claim 1, wherein said pipette tip has at least two plane-parallel windows on opposite sides of a wall of the pipette tip.

6. A UV absorbance measuring apparatus for measuring concentrations of protein or nuclei acid samples, said apparatus comprising: a pipette tip of claim 1; a pipette for drawing said samples into said pipette tip; a light beam transmitting through said pipette tip and said sample; and an optical detector for measuring the intensity of the transmitted light beam and the subsequent calculation of the concentrations of the samples.

7. The UV absorbance measuring apparatus of claim 6, wherein said light beam comprises a UV light having wavelengths between 200 nm and 350 nm.

8. The UV absorbance measuring apparatus of claim 6, further comprising at least one optical filter located in the path of said light beam for allowing at least one particular wavelength to transmit through said at least one optical filter.

9. The UV absorbance measuring apparatus of claim 8, wherein said particular wavelength is selected from a group consisting of 230 nm, 260 nm, 280 nm, and 320 nm.

10. A method for measuring concentrations of protein or nucleic samples, comprising:
providing a UV absorbance measuring apparatus, wherein said apparatus comprises a pipette tip of claim 1;
transporting said samples into said pipette tip;
passing a light beam through said pipette tip and said samples;
measuring intensity of the transmitted light beam; and
calculating the concentrations of the samples using the measured intensity.

11. The method of claim 10, wherein said light beam comprises a UV light having wavelengths between 200 nm and 350 nm.

12. The method of claim 10, further comprising at least one optical filter located in the path of said light beam for allowing at least one particular wavelength to transmit through said at least one optical filter.

13. The method of claim 12, wherein the particular wavelength is selected from a group consisting of 230 nm, 260 nm, 280 nm, and 320 nm.

14. The method of claim 10, wherein said protein comprises an amino acid selected from a group consisting of tyrosine, tryptophan, and phenylalanine.

15. The method of claim 10, wherein the concentrations of the samples are calculated by subtracting the intensity of the transmitted light beam through a blank pipette tip from the intensity of the transmitted light beam through the pipette tip that contains samples.
